(19) United States
(12) Patent Application Publication
(10) Pub. No.: US 2016/0197568 A1
(43) Pub. Date: Jul. 7, 2016

(54) DRIVING APPARATUS FOR MOTOR USING TIME DELAY COMPENSATION METHOD OF CURRENT DETECTING SENSOR COMBINED WITH FILTER

(71) Applicant: KOREA INSTITUTE OF OCEAN SCIENCE & TECHNOLOGY, Gyeonggi-do (KR)

(72) Inventors: So Young SUNG, Seoul (KR); Jong Won PARK, Daejeon (KR); Yong Kon LIM, Daejeon (KR); Seung Geun KIM, Daejeon (KR)

(21) Appl. No.: 14/905,998

(22) PCT Filed: Jul. 22, 2014
(86) PCT No.: PCT/KR2014/006665

§ 371 Date: Jan. 19, 2016

(30) Foreign Application Priority Data
Jul. 23, 2013 (KR) 10-2013-0086748

(51) Int. Cl. H02P 6/15

(52) U.S. Cl. CPC H02P 6/15

(57) ABSTRACT

The present invention relates to a driving apparatus for a motor. The driving apparatus for the motor is provided with a rotor position detection unit for detecting position information of a rotor of the motor, a motor driving unit for driving the motor by applying current to the motor, a current detection unit for detecting a current that is applied to the motor, a filter for removing noise included in a signal outputted from the current detection unit and outputting the signal, and a motor control unit for outputting, to the motor driving unit, a motor driving control signal in which the time delay from the filter is recorded and which compensates for the time delay to the signal from the filter. Using the driving apparatus for the motor, the drive of the motor can be controlled so as to compensate for the time delay from the filter using a value that is calculated in advance and memorised, thereby improving driving efficiency.

### TECHNICAL FIELD

The present invention relates to a driving apparatus for a motor, and more particularly, to a driving apparatus for a motor where a driving of the motor is controlled by detecting a current supplied to the motor.

### BACKGROUND ART

Generally, when controlling a rotation speed of a motor by detecting a current supplied to the motor, a filter such as a low pass filter, which removes noise included in a signal output from a current detection sensor that detects the current supplied to the motor, is employed, and an example of this is disclosed in Korean Laid-open Patent Publication No. 1994-0019956 “Motor Driving Circuit.”

However, since such a filter outputs a delayed current detection signal, the influence of a time delay due to the filter is minor for the efficiency of a driving of the motor in the case of controlling the driving of the motor at low speeds, but there is a problem in that the time delay causes a mismatching in the timing of supplying electric power corresponding to a rotor position information in the case that a rotation speed of the motor is fast, thereby degrading a driving efficiency.

### Technical Problem

The present invention is directed to providing a driving apparatus for a motor capable of precisely controlling the timing of a driving of the motor by compensating for a time delay caused by a filter.

### Technical Solution

One aspect of the present invention provides a driving apparatus for a motor which includes a motor; a rotor position detection unit which detects rotor position information of the motor; a motor driving unit which supplies electric power to drive the motor and drives the motor; a current detection unit which detects a current to be applied to the motor; a filter which removes noise included in a signal output from the current detection unit and outputs the signal; and a motor controller unit which compensates for a signal input via the filter with a delay time, and outputs a motor driving control signal corresponding to an output signal of the rotor position detection unit to the motor driving unit, wherein the delay time caused by the filter is pre-recorded; wherein the motor control unit includes a delay time look-up table in which the delay time caused by the filter is recorded; a delay phase compensator which generates a phase angle signal compensated for a delay time of the signal input via the filter with respect to the output signal of the rotor position detection unit by referring to the delay time look-up table; and a motor current controller which controls the motor driving unit using the phase angle signal provided by the delay phase compensator and the signal input via the filter.

At least one of a Bessel, an Eliptic, a Gaussian, and a finite impulse response (FIR) filter may be applied as the filter.

### Advantageous Effects

In the driving apparatus for a motor according to an exemplary embodiment of the present invention, a driving of the motor is controllable by compensating for a delay phase signal by using a pre-calculated and stored value of a time delay amount caused by a filter to automatically calculate a delay phase angle according to a speed of a rotor, and thereby improving the driving efficiency.

### DESCRIPTION OF DRAWINGS

FIG. 1 is a view illustrating a driving apparatus for a motor according to an embodiment of the present invention.

FIG. 2 is a detailed block diagram of a control unit shown in FIG. 1.

FIG. 3 is a graph illustrating a delay time of a filter applied to the embodiment of the present invention according to frequencies.

FIGS. 4 to 8 are graphs illustrating experimental results comparing a case of not compensating for a delay time to a case of compensating for the delay time.

### MODES OF THE INVENTION

Hereinafter, a driving apparatus for a motor according to a preferable embodiment of the present invention will be described in more detail with reference to the accompanying drawings.

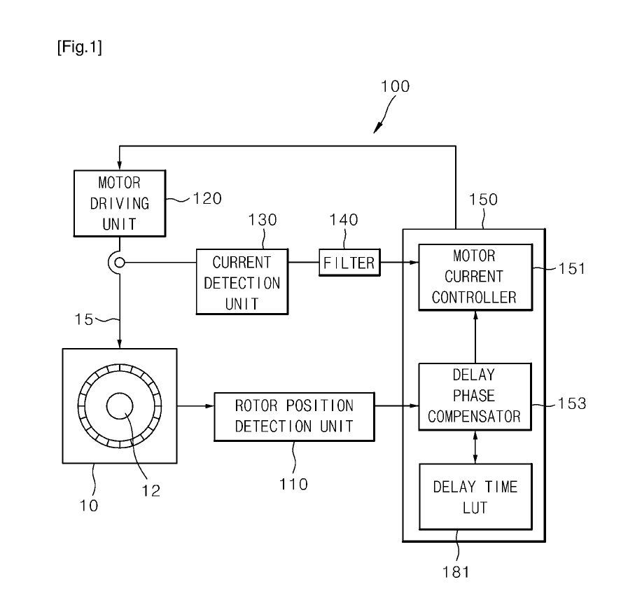

FIG. 1 is a view illustrating a driving apparatus for a motor according to an embodiment of the present invention.

Referring to FIG. 1, a driving apparatus for a motor 100 according to the present invention includes a rotor position detection unit 110, a motor driving unit 120, a current detection unit 130, a filter 140, and a motor control unit 150. A motor 10 rotates a rotor 12 by power supplied from the motor driving unit 120.

The rotor position detection unit 110 detects pole position information of the rotor 12 of the motor 10.

Various types of known sensors capable of detecting a position of the rotor 12 such as a hall sensor, an encoder, or the like may be applied as the rotor position detection unit 110.

The motor driving unit 120 controlled by the motor control unit 150 supplies power to the motor 10 to drive the motor 10.

The current detection unit 130 detects a current applied to the motor 10.

A current sensor, which externally detects an induced energy corresponding to the current supplied through a power supply line 15 from the motor driving unit 120 to the motor 10, is applied as the current detection unit 130.

The filter 140 removes noise included in a signal output from the current detection unit and outputs the signal.

A low pass filter is applied as the filter 140.

A filter, which removes a signal which exceeds a cut-off frequency and passes a signal at or below the cut-off frequency, is applied as the filter 140.

At least one of a Bessel, an Eliptic, a Gaussian, and a finite impulse response (FIR) filter is preferably applied as the filter 140.

Here, delay times of Bessel, Eliptic, Gaussian, and FIR filters are constant regardless of frequency when at or below a predetermined cut-off frequency.

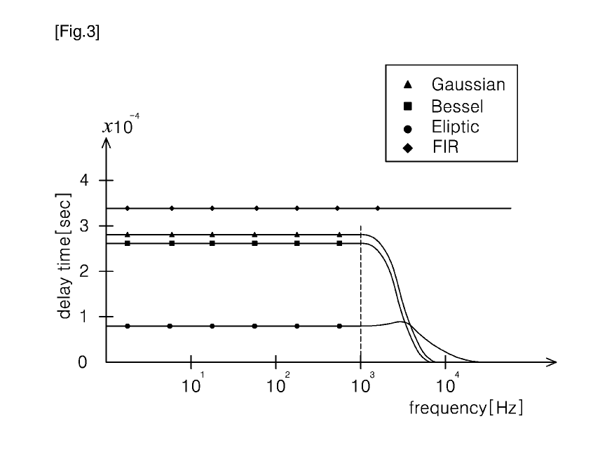

For reference, FIG. 3 is a graph illustrating values of time delays according to frequencies for Bessel, Eliptic, Gaussian, and FIR filters, which are designed to apply 1 KHz as a cut-off frequency. As illustrated, it showed that a delay time until the cut-off frequency of 1 KHz is constant regardless of frequency.

Accordingly, a delay time corresponding to the applied filter 140 is recorded and stored as a constant value, and by using a delay time value, which is recorded regardless of frequency, even in a calculation for calculating a compensation phase angle, complexity of the calculation may be suppressed.

A delay time caused by the filter 140 is recorded in a look-up table (LUT) 181 in advance, and the motor control unit 150 outputs a motor driving control signal to the motor driving unit 120 by calculating a compensated phase angle for the delay time from a phase angle calculated by using the speed of the motor 10 calculated from an output signal of the rotor position detection unit 110.

The motor control unit 150 includes a delay time LUT 181 in which a delay time caused by the filter 140 is recorded, a delay phase compensator 153 which, by referring to the delay time LUT 181, generates a compensated phase angle signal for a delay time for a signal received via the filter 140 with respect to the output signal of the rotor position detection unit 110, and a motor current controller 151 which controls the motor driving unit 120 to be a set rotation speed using the phase angle signal provided from a delay phase compensator 153 and a current value signal received via the filter 140.

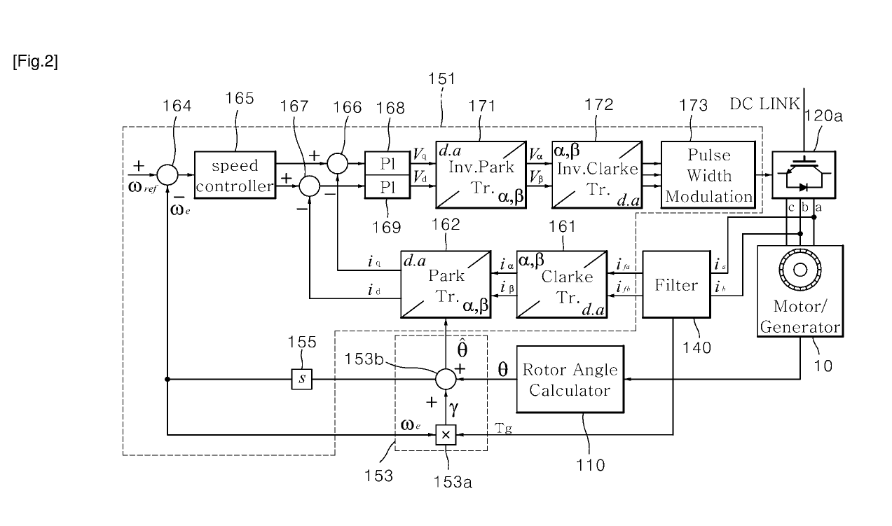

Such a process of controlling the motor control unit 150 will be described in more detail with reference to FIG. 2.

Referring to FIG. 2, the delay phase compensator 153 includes a first multiplier 153a and a first adder 153b, and the current controller 151 includes first to fourth phase converters 161, 162, 171 and 172, second and third adders 164, 166, and 167, a first and a second PI controller 168 and 169, and a pulse width modulator (PWM) 173.

First, with respect to two phase signals, for example, phases a and b among three-phase signals of a, b, and c applied to the three-phase motor 10 by switching a direct current (DC LINK) from an inverter 120a applied to the motor driving unit 120, the first phase converter 161 receives and phase-converts signals i_{fa} and i_{fb} output from the filter 140 via the current detection unit 130. The first phase converter 161 converts two phases among the phases a, b, and c, to an α-axis phase and a β-axis phase, respectively. That is, the first phase converter 161 performs a Clarke transform, receives an a-phase current signal ia and a b-phase current signal ib of the inverter 120a via the filter 140, phase-converts the a-phase current signal ia and the b-phase current signal ib to an α-axis current signal iα and a β-axis current signal iβ, and transmits the α-axis current signal iα and the β-axis current signal iβ to the second phase converter 162.

The second phase converter 162 converts the α-axis current signal iα and the β-axis current signal iβ provided from the first phase converter 161 to a d-axis feedback current signal id and a q-axis feedback current signal iq. The second phase converter 162 performs a Park transform.

Here, the d-axis feedback current signal id and the q-axis feedback current signal iq are converted by the second phase converter 162 in consideration of a compensated phase signal \hat{θ} by the delay phase compensator 153.

Moreover, the delay phase compensator 153 provides the second phase converter 162 with the compensated phase signal \hat{θ} generated by adding a compensation angle γ corresponding to a delay time Tg with respect to rotor position θ information output from the rotor position detection unit 110.

Here, the delay phase compensator 153 includes the first multiplier 153a which multiplies an angular velocity ωe obtained from the delay time Tg compensated phase signal \hat{θ}, by the delay time Tg recorded in the delay time look-up table 181, and a first adder 143b which adds the compensation angle γ, which is output from the first multiplier 153a, to the rotor position θ output from the rotor position detection unit 110.

A speed calculator 155 calculates information of the current angular velocity ωe by differentiating the compensated phase signal \hat{θ}.

Moreover, the second adder 164 provides a speed controller 165 with an angular speed difference information which is calculated by subtracting the angular velocity information we provided by the speed calculator (S) 155 from angular speed instruction information wref provided by a higher level (not shown) controller such that the delay time due to the filter 140 is compensated.

The speed controller 165 outputs a speed adjustment current value of the d-axis phase and the q-axis phase corresponding to the angular speed difference information to a third adder 166 and a fourth adder 167.

The third adder 166 subtracts the current feedback signal iq of the q-axis phase generated by the second phase converter 162 from the speed adjustment current value of the q-axis phase output from the speed controller 165, and provides the result to the first PI controller 168.

The fourth adder 167 subtracts the current feedback signal id of the d-axis phase generated by the second phase converter 162 from the speed adjustment current value of the d-axis phase output from the speed controller 165, and provides the result to the second PI controller 169.

The first PI controller 168 generates a q-axis voltage signal Vq from the received q-axis current information, and transmits the generated q-axis voltage signal Vq to the third phase converter 171.

The second PI controller 169 generates a d-axis voltage signal Vd from the received d-axis current information, and transmits the generated d-axis voltage signal Vd to the third phase converter 171.

The third phase converter 171 phase-converts the d-axis voltage signal Vd and the q-axis voltage signal Vq to an α-axis voltage signal Vα and a β-axis voltage signal Vβ.

That is, the third phase converter 171 performs an inverse Park transform.

This third phase converter 171 receives the q-axis voltage signal Vq and the d-axis voltage signal Vd from the first PI controller 168 and the second PI controller 169, and transmits the α-axis voltage signal Vα and the β-axis voltage signal Vβ to the signal converter 172 after converting the received signals.

The fourth phase converter 172 outputs a three-phase (a, b, and c) control signal for controlling the inverter 172 by converting the a-axis voltage signal Vα and the β-axis voltage signal Vβ. Here, the fourth phase converter 172 performs an inverse Clarke transform, and provides a three-phase fixed coordinate physical quantity to the PWM modulator 173 by converting a two-phase physical quantity.

That is, the fourth phase converter 172 provides a three-phase physical quantity to the PWM modulator 173 by converting the α-axis voltage signal Vα and the β-axis voltage signal Vβ.

The PWM modulator 173 generates a pulse signal corresponding to a three-phase driving signal from a signal output from the fourth phase converter 172, and outputs the pulse signal to the inverter 120a.

The inverter 120a switches such that a driving current corresponding to the pulse signal output from the PWM modulator 173 is applied to the motor 10.

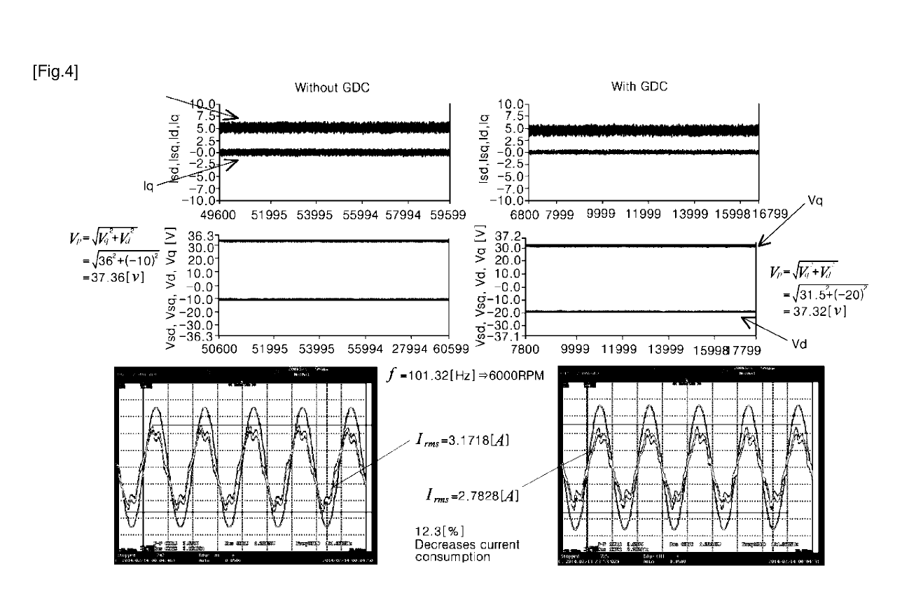

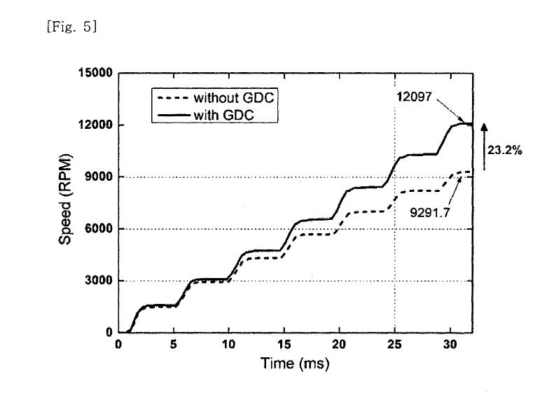

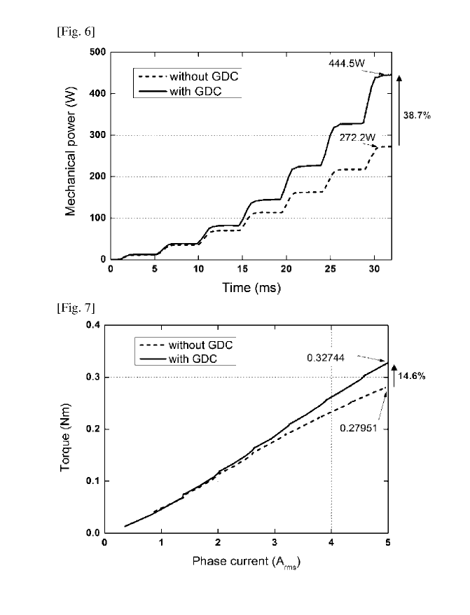

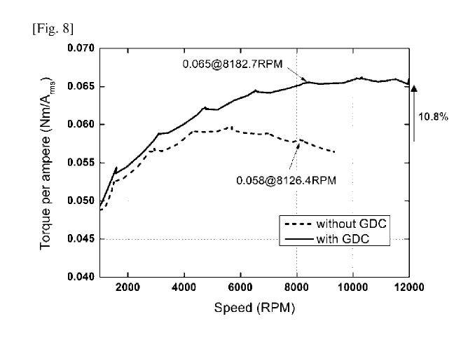

For such a driving apparatus for a motor 100, experimental results comparing a case of not compensating for a time delay cause by the filter 140 to a case of compensating for the time delay is illustrated in FIGS. 4 to 8.

As shown in FIG. 4, a driving current was decreased by 12.3% in the case of compensating for the time delay compared to the case of not compensating for the time delay caused by the filter 140.

In FIG. 4, the graph marked as with GDC is the result of an experiment in which the delay time was compensated for according to the embodiment of the present invention, and the graph marked as without GDC is the result of an experiment in which the delay time was not compensated for.

In addition, in FIGS. 4 to 8 where the results of the experiment are illustrated, the graph marked by a solid line (with GDC) is the experimental result of compensating for the delay time according to the embodiment of the present invention, and the graph marked by a dotted line (without GDC) is the experimental result of not compensating for the delay time.

As shown in FIGS. 4 to 8, for the driving apparatus for a motor 100, when the case of compensating for the time delay caused by the filter 140 is compared to the case of not compensating for the time delay, it showed that increasing a rotation speed of the motor 10 to be faster than the case of not compensating for the time delay during the same period of time is possible, and it is possible to be sure of obtaining a higher torque for the same amount of applied current.

In addition, while the current value per torque gets smaller as the rotation speed of the motor 10 increases in the case of not compensating for the delay time, the current value per torque maintains a constant level when the delay time is compensated for, and this can be seen as much more advantageous in high speed controlling.

1. A driving apparatus for a motor, comprising:
a motor;
a rotor position detection unit which detects rotor position information of the motor;
a motor driving unit which supplies electric power to the motor and drives the motor;
a current detection unit which detects a current to be applied to the motor;
a filter which removes noise included in a signal output from the current detection unit and outputs the signal; and
a motor control unit which compensates for a signal input via the filter with a delay time, and outputs a motor driving control signal corresponding to an output signal of the rotor position detection unit to the motor driving unit, wherein the delay time caused by the filter is pre-recorded;
wherein the motor control unit includes:
a delay time look-up table in which the delay time caused by the filter is recorded;
a delay phase compensator which generates a phase angle signal compensated for a delay time of the signal input via the filter with respect to the output signal of the rotor position detection unit by referring to the delay time look-up table; and
a motor current controller which controls the motor driving unit using the phase angle signal provided by the delay phase compensator and the signal input via the filter.

2. The driving apparatus for a motor of claim 1, wherein at least one of a Bessel, an Eliptic, a Gaussian, and a finite impulse response (FIR) filter is applied.

3. The driving apparatus for a motor of claim 2, wherein:
a filter, which removes a signal exceeding a cut-off frequency and passes a signal at or below the cut-off frequency, is applied to the filter; and
a current sensor, which externally detects an induced energy corresponding to the current supplied through a power supply line from the motor driving unit to the motor, is applied to the current detection unit.
